(19) United States
(12) Patent Application Publication
(10) Pub. No.: US 2007/0275125 A1
(43) Pub. Date: Nov. 29, 2007

(54) METHOD OF DELIVERING AN ACTIVE COMPONENT TO A LIQUID FOODSTUFF IN A CONTAINER WITH A NARROW OPENING

(76) Inventor: Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/420,565

(22) Filed: May 26, 2006

(51) Int. Cl. A23L 1/236; A23L 1/27; A23L 1/28; A23L 1/302; A23L 1/48; A23L 2/38; B67D 5/00

(52) U.S. Cl. 426/72; 426/250; 426/531; 426/548; 426/590; 426/655; 99/275

(57) ABSTRACT

Methods to deliver an active component to a liquid foodstuff in a container with a narrow opening, for example, a beverage in a bottle, are provided. More particularly, a method is provided for delivering an active component to a liquid foodstuff in a container with a narrow opening. This method includes the steps of a) positioning a nozzle of a spraying device that produces a spray when the spraying device is activated in the opening of the container such that the spray produced by the nozzle travels an axis substantially perpendicular to the surface of the liquid foodstuff in the bottle and b) spraying at least one unit dose of a solution containing a hydrophilic substance and a solvent onto the surface of the liquid foodstuff in the container using the spraying device. Using this method, the active component is dispersed throughout the liquid foodstuff without additional mixing.

### FIELD OF THE INVENTION

The present invention relates to methods to deliver an active component to a liquid foodstuff in a container with a narrow opening, for example, a beverage in a bottle. More particularly, the present invention relates to a method for delivering an active component to a liquid foodstuff in a container with a narrow opening.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for mechanisms that consumers may use to increase the sweetness of a product at the time of consumption that are consistent with their personal preferences and that produce minimal additional caloric burden.

The availability of high intensity sweeteners provides the ability to minimize the caloric burden involved with adding additional sweetness to a foodstuff, e.g., individual servings of beverages. For example, sucralose is about 500 to about 600 times as sweet as sucrose (a.k.a. table sugar and cane sugar). One teaspoon of sucrose (about 4-5 grams) may be replaced by about 6.7 to 10 milligrams of sucralose. The minute quantities of high intensity sweeteners needed to achieve preferred sweetening of individual servings offer the opportunity to provide new technologies to deliver sweetness to foodstuffs, including individual servings.

Sweetening individual servings of, for example, a beverage presents a challenge in many food service situations. Frequently, at least one individual packet of a sweetener is provided along with a serving of a beverage. The packet may contain sucrose, or alternatively may contain a high intensity sweetener, such as, sucralose, aspartame, or saccharin.

However, sweetening a beverage using sweetener packets presents a number of disadvantages. For example, once opened, the entire packet and its contents must be disposed of, whether used as sweetener or discarded as waste, since there is no simple way of storing an opened packet without spillage. The consumer opens the packet, empties the contents into the beverage, and then stirs the beverage to dissolve the sweetener into the liquid foodstuff. The residual packaging of the packet, unused sweetener, and the device used to stir the beverage, e.g., straw or stick, create waste. Furthermore, the transportability of individual sweetener packets may be considered by some to be inconvenient due to their size and weight.

Liquid sweetener products have also been developed. These also suffer disadvantages, including the difficulty in assuring drops are directed into the narrow opening.

Tablets and cubes are disadvantaged by the time required to dissolve. All methods require the cap to be replaced prior to consumption to allow mixing.

In view of the foregoing, it would be advantageous to provide a method of delivering an active component, e.g., a sweetener, to a liquid foodstuff without mixing.

### SUMMARY OF THE INVENTION

One embodiment of the present invention is directed to a method for delivering an active component to a liquid foodstuff in a container with a narrow opening, comprising, consisting of, and/or consisting essentially of using a spraying device to spray a unit dose of a solution onto the surface of the liquid foodstuff in the container, wherein the solution comprises, consists of, and/or consists essentially of the active component and a solvent.

Another embodiment of the present invention is a method of delivering an sucralose to a beverage in bottle having a narrow opening, comprising, consisting of, and/or consisting essentially of using a spraying device to spray a unit dose of a solution onto a surface of the liquid foodstuff in the container, wherein the solution comprises, consists of, and/or consists essentially of sucralose and water, the device comprises, consists of, and/or consists essentially of a body and an activating flange disposed about an outer surface of the body, and the unit dose is sufficient to produce a Sucrose Sweetness Equivalent to about one teaspoon of sucrose.

An additional embodiment of the present invention is a method for delivering an sucralose to a beverage in bottle a narrow opening, comprising, consisting of, and/or consisting essentially of using a spraying device to spray a unit dose of a solution onto the surface of the liquid foodstuff in the container, wherein the solution comprises, consists of, and/or consists essentially of sucralose and water, the device comprises an activating flange disposed about an outer surface of the body, the method comprising, consisting of, and/or consisting essentially of and the unit dose is sufficient to produce a Sucrose Sweetness Equivalent to about one teaspoon of sucrose.

### BRIEF DESCRIPTION OF THE DRAWINGS

FIG. 1 shows an exterior view of an embodiment of a spraying device.

FIG. 2 shows a cross section of an embodiment of a spraying device in a resting position.

FIG. 3 shows a cross section of an embodiment of a spraying device in a spraying position.

### DETAILED DESCRIPTION OF THE INVENTION

As used herein, the term “container with a narrow opening” means a structure for holding a liquid with an opening allowing access to a cavity for holding a volume of liquid defined by the container wherein the opening has a circumference that is less than about one-half the circumference of the container. The opening may be resealable or may be opened only once and not able to be resealed. Examples of containers with a narrow opening include bottles, cans, cartons, jugs, bags (e.g., juice bags), and the like. Preferably, the container with a narrow opening is a bottle, such as, a bottle for holding water, seltzer, or iced tea.

As used herein, the term “positioning a nozzle of the spraying device in the opening of the container” means placing a portion of the spraying device including the nozzle within the opening of the container such that the spray produced by the nozzle of the spraying device travels an axis substantially perpendicular to the surface of the liquid foodstuff in the container and is delivered directly to the surface of the liquid foodstuff.

As used herein, the term “liquid foodstuff” means an ingestible material that is a fluid, e.g., a beverage, such as, water, coffee, or tea, or an ingestible material that has a fluid base and retains fluid-like properties, e.g., a soup or sauce. Liquid foodstuffs useful in the present invention include, e.g., coffee, tea, water, seltzer, milk, juices, liquors, spirits, beer, ales, soups, sauces, gravies, and the like. Preferably, the liquid foodstuff is coffee, tea, or water.

As used herein, the term “spraying device” means any device with a nozzle and a means to provide a pressurized fluid to said nozzle to produce a spray with a velocity along a spray axis. The spraying devices of the present invention may produce spray patterns of any shape and dimension that delivers substantially all of the unit dose of solution sprayed to the liquid beverage when the spraying device is activated. Preferably, the spraying pattern has an average of the height and width is less than about two inches at a distance of about two inches from the spraying device. Preferably, the spray pattern has an average of the height and width of less than about one inch at a distance of about two inches from the spraying device. The spraying devices of the present invention may be selected to produce desired spray patterns. Spray patterns useful in the present invention include, for example, circles, ovals, squares, rectangles, triangles, and regular polygons.

Examples of spraying methods and devices useful in the present invention include motor driven centrifugal or positive displacement pumps, finger driven positive displacement pumps, finger driven squeeze pumps, aerosol pressurization, and other methods and devices known to those skilled in the art. Preferably, the spraying device is a finger driven squeeze pump.

In addition, the spraying device may include an activating flange. As used herein, the term “activating flange” means a protrusion that allows the spraying device to be activated by maintaining the activating flange in a stationary position, e.g., against a rim of a neck of a bottle, and pressing the body of the spraying device or the reservoir toward the activating flange.

As used herein, the term “adequate velocity” or “velocity adequate to disperse” means a velocity sufficient to achieve dispersion of the active component in the liquid food stuff sufficient for consumption by a consumer, without the need for additional mixing, e.g., resealing a bottle and shaking. In an embodiment of the present invention, activation of the spraying device produces a spray with a velocity substantially along the axis adequate to disperse the active component throughout the container with a narrow opening without additional mixing.

In an embodiment of the present invention, the spray has velocity along the an axis substantially perpendicular to the surface of the liquid foodstuff, i.e., if the spraying device is pushed to activate, then the spray produced by the nozzle of the spraying device will have a principle velocity vector parallel to the axis and in a direction from the nozzle toward the surface of the liquid foodstuff.

As used herein, the term “unit dose” means a predetermined amount of active component sufficient to provide a desired attribute, e.g., sweetness level, to the liquid foodstuff. Preferably, a unit dose provides sweetness that can be equivalent to from about one-half teaspoon to about three teaspoons of sucrose, preferably from about one teaspoon to about two teaspoons. The delivery of a unit dose is dependent on the concentration of the active component in the solution and the volume of the solution delivered. The volume of solution needed to deliver a unit dose of the active component is inversely proportional to the concentration of the active component in the solution. For example, if the concentration of the active component in the solution is doubled only one half of the volume must be sprayed to deliver the same unit dose. In the present invention, multiple unit doses may be delivered as desired.

Using the device of the present invention, a consumer expects that an active component, e.g., a sweetener, will be delivered in a specific quantity. The Just Noticeable Difference (JND) is a measure of the difference from the amount of sweetener expected that produces a difference in sweetness noticeable by a consumer. The JND is about ±5%. Accordingly, a high intensity sweetener should be delivered in an amount in the range that does not produce a JND (or greater difference) to satisfy the consumer.

Accordingly, while the volume of solution delivered is adjustable or fixed, the spraying device must deliver a volume that is accurate, i.e., is the same as that volume selected, from one spray to the next.

As used herein, the term “substantially all of the unit dose” means that amount of the unit dose required to deliver enough of the active component to the liquid foodstuff to produce a change in the foodstuff not noticeably different from that expected by the consumer. For example, for sweetness substantially all of the unit dose means that amount of the unit dose required to deliver a sweetness that does not produce a JND (or greater difference).

In an embodiment of the present invention a) the container is a bottle having a neck that terminates with a rim that circumscribes an opening into the bottle, b) the spraying device further includes an activating flange adapted to be positioned over the rim of the neck of the bottle, c) the positioning step includes positioning the nozzle in the opening and the activating flange over the rim, and d) the spraying step includes pushing the body of the spraying device toward the activating flange thereby activating the spraying device and delivering a unit dose of the solution to the liquid foodstuff.

To provide flexibility in the amount of high intensity sweetener delivered, more than one spraying device may be provided, each spraying device delivering a different volume of the solution in a single spray. Accordingly, the amount of high intensity sweetener may be adjusted by selecting the spraying device. For example, if twice the amount of sweetness is desired, then a device that delivers twice the volume of solution may be selected.

In addition, the spraying device of the present invention may allow for the selection between two or more solutions with different concentrations of an active component, e.g., a high intensity sweetener, or the combination of two or more solutions into a single spray. In this manner, the amount of high intensity sweetener, and, if desired, additional active components, is highly adjustable.

As used herein, “active component” means any substance that dissolves or can be suspended in a liquid, which comprises water with or without other solutes. Examples of useful active components include high intensity sweeteners, nutritive sweeteners, sugar alcohols, flavors, drug substances, vitamins, minerals, texture enhancers, coloring agents, aromas, preservative/buffer systems, and combinations thereof. A preferred active component according to the present invention is a high intensity sweetener.

As used herein, the term “high intensity sweetener” means a substance that provides a high sweetness per unit mass as compared to sucrose and provides little or no nutritive value. Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol or iso-steviol, thaumatin, salts, derivatives, and combinations thereof. A preferred sweetener according to the present invention is sucralose.

As used herein, a gram (or other given amount) of “Sucrose Equivalent Sweetness” means the amount of high intensity sweetener needed to be added to an 8 ounce glass of water in order to provide the same sweetness as an independent 8 ounce glass of water containing 1 gram (or the other given amount) of sucrose. For example, 1/200 gram of aspartame will equal about 1 gram of Sucrose Equivalent Sweetness because aspartame is about 200 times sweeter than sucrose. Similarly, about 1/500 gram to about 1/600 gram of sucralose will provide one gram of Sucrose Equivalent Sweetness because sucralose is about 500 to about 600 times sweeter than sucrose. Therefore, one teaspoon of sucrose (about 4-5 grams) may be replaced by about 6.7 to 10 milligrams of sucralose.

As used herein, all numerical ranges provided are intended to expressly include at least all numbers that fall between the endpoints of ranges.

As used herein, the term “nutritive sweetener” means a substance that provides sweetness and is also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from, e.g., sugar cane and sugar beet roots. Examples of nutritive sweeteners include, e.g., corn syrup, glucose, fructose, tagatose, high fructose corn syrup, lactose, sucrose, trehalose, lactose, arabinose, maltodextrin, soluble starch, insulin, and the like, alone or in combination.

As used herein, “sugar alcohol,” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, “drug substance” means materials with pharmacological or nutritional benefits. Drug substances useful in the present invention include, for example, acetaminophen, ibuprofen, famotidine, chlorpheniramine, phenylephrine, pseudoephedrine, dextromethorphan, diphenhydramine, brompheniramine, clemastine, phenylpropanolamine, terfenadine, astemizole, loratadine, loperamide, loperamide-N-oxide, ranitidine, cimetidine, tramadol, cisapride, acetylsalicylic acid, doxylamine succinate, pharmaceutically acceptable salts thereof and combinations thereof.

As used herein, “flavor” means any substance that may be employed to produce a desired flavor. Any flavor know to those skilled in the art may used in the present invention. The flavor used may be selected based on the type of foodstuff that will be contacted with the device for delivering an active component. Flavors useful for flavoring coffee include, for example, cream, hazelnut, vanilla, chocolate, cinnamon, and pecan. In contrast, flavors useful for flavoring tea include, for example, lemon, lime, raspberry, peach, and mango. Blends of flavors are also suitable for these applications. Useful flavors include, for example, the above-mentioned flavors and vanillin, butter, butterscotch, tea, orange, tangerine, walnut, caramel, strawberry, banana, grape, plum, cherry, blueberry, pineapple, elderberry, watermelon, bubblegum, cantaloupe, guava, kiwi, papaya, coconut, mint, spearmint, green tea, chai, and pomegranate, and combinations thereof.

As used herein, “texture enhancer” means any substance that may be employed to produce a desired texture. Texture enhancers useful in the present invention include, for example, guar gum, alginate and salts thereof, taro gum, gellan gum, xanthium gum, amalose, amalopectin, konjac, and combinations thereof.

As used herein, “coloring agent” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), Annatto Extract, Anthocyanis, Aronia/Redfruit, Beet Juice & Powder, Beta-Carotene, Beta-APO-8-Carotenal, Black Currant, Burnt Sugar, Canthaxanthin, Caramel, Carbo Medicinalis, Carmine, Carmine/Beta-Carotene, Carmine Blue, Carminic Acid, Carrot & Carrot Oils, Chlorophyll, Chlorophyllin, Cochineal Extract, Copper-Chlorophyll, Copper-Chlorophyllin, Curcumin, Curcumin/CU-Chlorophyllin, Elderberry, Grape & Grape Skin Extracts, Hibiscus, Lutein, Mixed Carotenoids, Paprika, Paprika Extract, Paprika Oleoresin, Riboflavin, Saffron, Spinach, Stinging Nettle, Titanium Dioxide, Turmeric, and combinations thereof.

As used herein, “aroma” means any volatile substance that may be employed to produce a desired scent. Aroma components useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone juniper, common sage, Nootka cypress, and wormwood), thymol (camphor-like), trimethylamine (fish), vanillin (vanilla), salts, derivatives, and combinations thereof. Preferred aromas according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

As used herein, “preservative/buffer system” means any food grade substance that may be employed to extend the shelf life of another hydrophilic substance. Preservative/buffer systems useful in the present invention include, for example, a preservative system selected from the group consisting of potassium sorbate, sodium benzoate, potassium benzoate, methyl gallate, propyl gallate, ethylenediaminetetraacetate, methyl paraben, propyl paraben and mixtures thereof, a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic and a liquid, wherein the pH of the composition is from about pH 4.0 to about pH 5.5, and combinations thereof. Preferred preservative/buffer systems according to the present invention are a preservative system consisting of potassium sorbate and sodium benzoate, a buffering system consisting of citric acid and sodium citrate, and combinations thereof.

As used herein, a “food-grade” material is one that conforms to the standards for foods deemed safe for human consumption set forth in the Codex Alimentarius produced by the World Health Organization (1999).

As used herein, the term “solution” means a composition containing a high intensity sweetener dissolved or suspended in a solvent. In an embodiment of the present invention, the solution contains sucralose dissolved in water. Preferably, the sucralose is present in the solution in an amount from about 5% to about 25% based on the total weight of the solution. More preferably, the sucralose is present in the solution in an amount from about 10% to about 25%, even more preferably from about 12% to about 15%, based on the total weight of the solution. In an embodiment of the invention the solution contains sucralose and a lemon flavor dissolved in water.

As used herein, the term “solvent” means any food-grade liquid useful to dissolve or suspend one or more active components. Examples of solvents useful in the present invention include water, ethanol, ethyl acetate, propylene glycol, and combinations thereof. Preferably, the solvent is water.

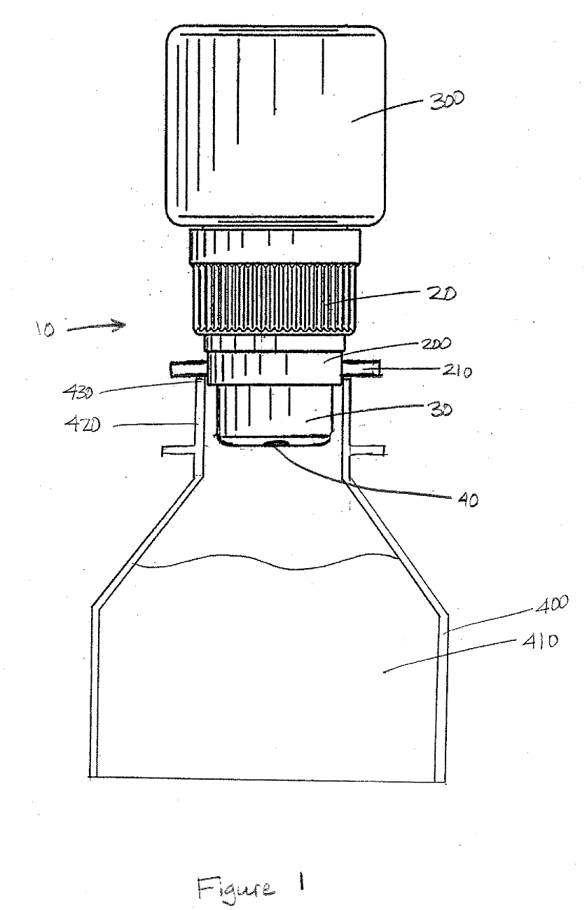

Turning now to the figures, exemplary methods and devices for carrying out the present invention are described. For example, FIGS. 1-3 show a manually activated pump embodiment of the spraying device of the present invention. FIG. 1 depicts an external view of a spray device capable of being used in the present invention. The finger driven squeeze pump (10) has a pump body (20) with a button cap (30) coupled to a first end (20a) of the pump body (20). The first end (20a) is opposite a second end (20b). The pump body (20) has a cuff (200) that has a diameter able to fit within a neck (420) of a bottle (400) containing liquid (410). The button cap (30) has an integral activating flange (210) that rests upon the rim (430) of the bottle (400) when the spray pump (10) is disposed in the neck (420) of the bottle. When the user presses the pump body (20) downward, the activating flange (210) engages the rim (430) of the bottle (400) and the button cap (30) is pushed down toward the second end (20b) of the pump body (20), the spray pump is activated.

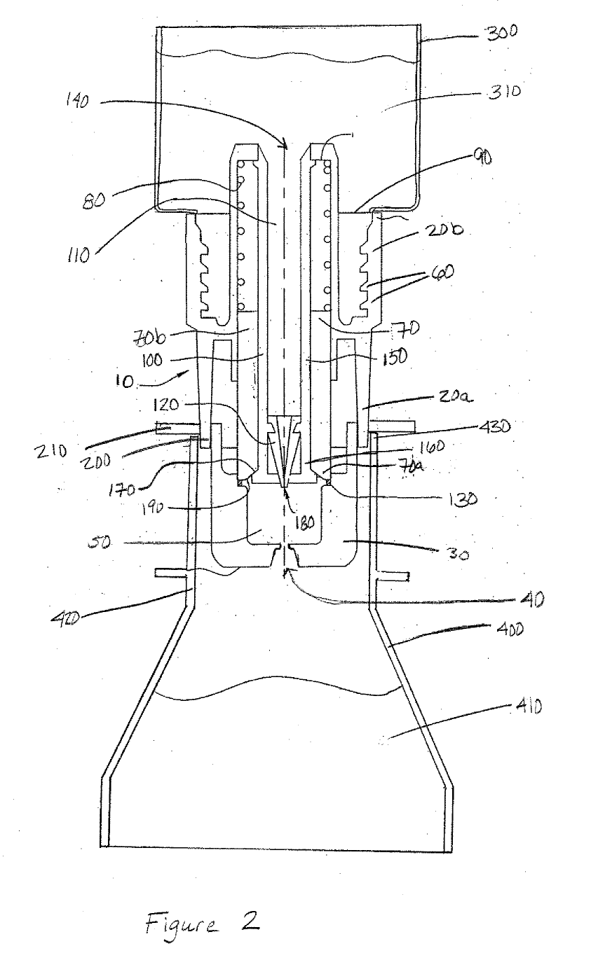

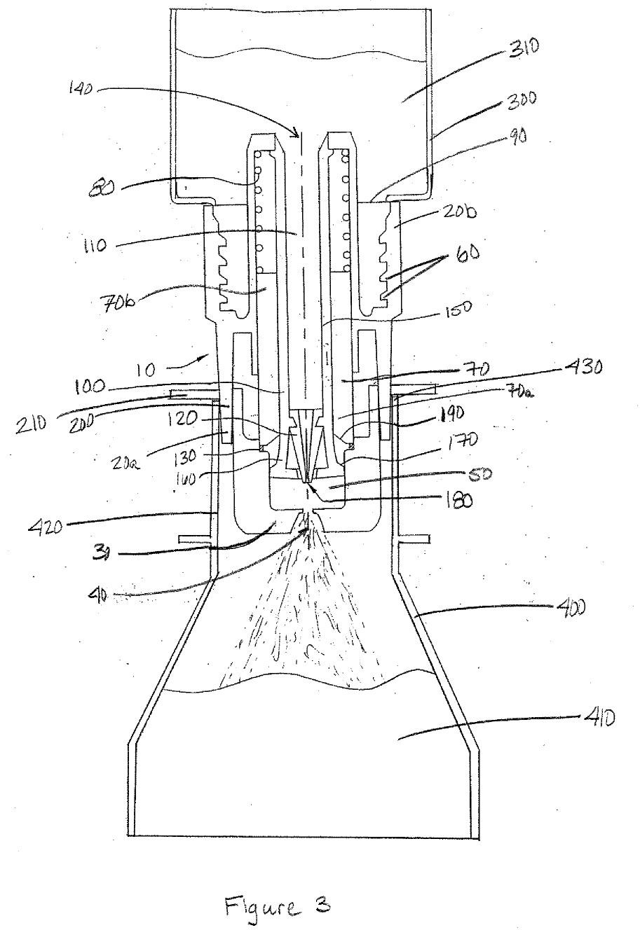

Turning to FIGS. 2 and 3, each show a cross section of a spray device that can be used in the present invention. Enclosed within the pump body (20) is a plunger (70) that moves between an extended position (FIG. 2) and a depressed position (FIG. 3). A biasing member (80), such as a spring, is coupled to and extends between a second end (70b) of the plunger (70) and an end wall (90) of the pump body (20). A stationary tube (100) having a passage (110) around a central axis is encompassed within the plunger (70). A duckbill valve (120) is provided in the passage (110) of the stationary tube (100) at the first end (20a) of the pump body (20).

The button cap (30) has a spray orifice (40) and a pump chamber (50) that contains fluid to be dispensed out the spray orifice (40). Interior threads (60) on the pump body (20) are capable of coupling the pump body (20) to external threads on a reservoir or body (300) containing a solution containing the active component (310) to be dispensed to the liquid (410).

The pump seals against leakage through a seal (130) between the button cap (30) and the pump body (20). This seal is beneficial in preventing leakage during shipping, handling and storing the product. The upward pressure from the biasing member (70) ensures the seal is maintained.

A fluid inlet (140) extends through passage (110) along the length of the pump body (20) to duckbill valve (120).

The stationary tube (100) has a main portion (150) coupled with the second end 20b of the pump body (20) and has opposing fingers (160) with a backside (170) that corresponds with the first end (70a) of the plunger (70). The opposing fingers (160) are made of a stiff material, e.g., plastic, and have a spring like quality. When in the closed position as depicted in FIG. 2, the flexible and resilient opposing fingers (160) are preferably shaped substantially as an inverted “U,” where inside the U-shape is the duckbill valve (120). Individually, the fingers (160) are substantially L-shaped. The two fingers come together to pinch closed a slit (180) in the top of the duckbill valve (120).

The plunger (70) further has a cam surface (190) at the first end (70a) that is sloped down toward the center of the pump body (20) from the seat for the seal (130). When in the extended position, the backside (170) of the L-shaped fingers (160) rest against a portion of the cam surface 190 and are forced together into the closed position by the interior surface of the plunger (14).

The biasing member (80) urges the plunger (70) to the extended position toward the first end (20a) of the pump body (20), thereby urging the opposed fingers (160) to the closed position. As a result, the slit (180) of the duckbill valve (120) automatically closes when the device is in an extended position, such that the user will not have to remember or make any additional actions in order to close off the duckbill valve (120).

When the user presses the button cap (30) down toward the second end (20b) of the pump body (20), the spray pump is activated. The fluid in the pump chamber (50) compresses and is forced out the spray orifice (40). The seal (130) that is coupled with the button cap (30) presses down with the button cap (30) into the plunger (70). Then the plunger (70) translates toward the second end (20b) of the pump body (20) into the depressed position, thereby compressing the biasing member (80). The volume of the pump chamber (50) remains at a minimum while the plunger is in this depressed position.

As the plunger (70) translates, the cam surface (190) and the interior surface of the plunger slide down along the opposing fingers (160) thereby releasing the fingers from the force holding them together. The resilience of the opposing fingers springs them apart as they return to an original shape. The movement of the plunger (70) only affects the fingers (160) of the stationary tube (150). The main portion (150) of the stationary tube does not translate or pivot when the plunger (70) moves.

The following examples are provided to further illustrate the compositions and methods of the present invention. These examples are illustrative only and are not intended to limit the scope of the invention in any way.

### EXAMPLES

### Example 1

A liquid foodstuff is sweetened using the method of the present invention wherein the spraying device is a finger driven squeeze pump delivering 0.1 milliliters of solution per spray. The spraying device includes an activating flange. The spraying device produces a circular spray pattern having an average of the height and width (diameter) of 1 inch at two inches from the spraying device.

A solution is made by combining 25.31 grams of sucralose with 183.11 milliliters of tap water. The solution is then heated to about 130° F. and mixed until clear. The solution is allowed to cool to room temperature. Once cooled a portion of the solution is loaded into a reservoir and the reservoir is attached to the spraying device.

The spraying device is positioned in the neck of a 20-ounce bottle of water and used to deliver a single spray to the surface of the water. The reservoir or body of the spraying device is pushed down and the activating flange is pressed against the rim of the neck of the bottle activating the spraying device and delivering a unit dose of the solution to the liquid foodstuff. A tester tastes the water and reports that, without stirring, the spray produces a sweetness in the water equivalent to about two teaspoons of sucrose in the water.

### Example 2

A liquid foodstuff is sweetened using the method of the present invention wherein the spraying device is a finger driven positive displacement pump delivering 0.25 milliliters of solution per spray. The spraying device produces a circular spray pattern having an average of the height and width (diameter) of 1 inch at two inches from the spraying device.

A solution is made by combining 2 grams of sucralose with 50 milliliters of tap water. The solution is then heated to about 130° F. and mixed until clear. The solution is allowed to cool to room temperature. Once cooled a portion of the solution is loaded into a reservoir and the reservoir is attached to the spraying device.

The spraying device is positioned in the neck of a 16-ounce bottle of seltzer and used to deliver a single spray to the surface of the seltzer. A tester tastes the seltzer and reports that, without stirring, the spray produces a pleasant sweetness in seltzer.

### Example 3

A liquid foodstuff is sweetened using the method of the present invention wherein the spraying device is a finger driven squeeze pump delivering 0.25 milliliters of solution per spray. The spraying device produces a triangular spray pattern having an average of the height and width of 1 inches at two inches from the spraying device.

A solution is made by combining 2 grams of sucralose and 100 milligrams of lemon flavor with 50 milliliters of tap water. The solution is then heated to about 130° F. and mixed until clear. The solution is allowed to cool to room temperature. Once cooled a portion of the solution is loaded into a reservoir and the reservoir is attached to the spraying device.

The spraying device is positioned in the neck of a 12-ounce can of unsweetened iced tea and used to deliver a single spray to the surface of the unsweetened iced tea. A tester tastes the unsweetened iced tea and reports that, without stirring, the composition produces a uniform pleasant sweetness in the unsweetened iced tea equivalent and a pleasing lemon flavor.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents.

What is claimed is:

1. A method for delivering an active component to a liquid foodstuff in a container with a narrow opening, comprising using a spraying device comprising a body to spray a unit dose of a solution onto the surface of the liquid foodstuff in the container, wherein the solution comprises the active component and a solvent.

2. A method according to claim 1, wherein the spraying device is manually operated.

3. A method according to claim 1, wherein the solution when sprayed has a velocity adequate to disperse the active component throughout the container without additional mixing.

4. A method according to claim 3, wherein the sprayed solution has a spray pattern with an average of the height and width that is less than about two inches at a distance of about two inches from a source of the spray device.

5. A method according to claim 4, wherein the spray pattern has an average of the height and width that is less than about 1 inch at a distance of about 2 inches from the spraying device.

6. A method according to claim 1, wherein the active component is selected from the group consisting of high intensity sweeteners, nutritive sweeteners, sugar alcohols, flavors, drug substances, vitamins, minerals, texture enhancers, coloring agents, aromas, preservative/buffer systems, and combinations thereof.

7. A method according to claim 6, wherein the active component is a high intensity sweetener.

8. A method according to claim 7, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol or iso-steviol, thaumatin, salts, derivatives, and combinations thereof.

9. A method according to claim 8, wherein the high intensity sweetener is sucralose.

10. A method according to claim 9, wherein one unit dose delivers about one half teaspoon to about three teaspoons of Sucrose Equivalent Sweetness to the liquid foodstuff.

11. A method according to claim 10, wherein one unit dose delivers about one teaspoon to about two teaspoons of Sucrose Equivalent Sweetness to the liquid foodstuff.

12. A method according to claim 1, wherein the solvent is selected from the group consisting of water, ethanol, ethyl acetate, propylene glycol, and combinations thereof.

13. A method according to claim 12, wherein the solvent is water.

14. A method according to claim 1, wherein the solution further comprises at least one additional component.

15. A method according to claim 14, wherein the additional component is selected from the group consisting of additional high intensity sweeteners, flavors, drug substances, vitamins, minerals, texture enhancers, coloring agents, aromas, preservative/buffer systems, and combinations thereof.

16. A method according to claim 15, wherein the additional component is lemon flavor or a preservative/buffer system.

17. A method according to claim 1, wherein
a) the container is a bottle having a neck that terminates with a rim that circumscribes an opening into the bottle,
b) the spraying device further comprises an activating flange adapted to be positioned over the rim of the neck of the bottle, and
c) the spraying step comprises pushing the body of the spraying device toward the activating flange thereby activating the spraying device and delivering a unit dose of the solution to the liquid foodstuff.

18. A kit for implementing the method of claim 1 comprising, in packaged combination, a spraying device and instructions for using the spraying device, wherein the spraying device is capable of spraying a unit dose of a solution onto a surface of a liquid foodstuff in a container, wherein the solution comprises the active component and a solvent and the device comprises an activating flange disposed about an outer surface of the body.

19. A method of delivering an sucralose to a beverage in a bottle having a narrow opening, the method comprising using a spraying device to spray a unit dose of a solution onto a surface of the liquid foodstuff in the container, wherein the solution comprises sucralose and water, the device comprises a body and an activating flange disposed about an outer surface of the body, the method comprising and the unit dose is sufficient to produce a Sucrose Equivalent Sweetness of about one teaspoon of sucrose.

20. The method according to claim 19, wherein spraying the unit dose of the solution is carried out by pushing the body of the spraying device toward the activating flange.
